(19) United States
(12) Patent Application Publication
(10) Pub. No.: US 2006/0041457 A1
(43) Pub. Date: Feb. 23, 2006

(54) System and method for forming business alliances

(76) Inventors: Scott Mueller, Chagrin Falls, OH (US); Richard Cahoon, Cleveland Heights, OH (US); Dean Mueller, Westlake, OH (US)

Correspondence Address: PEPPER HAMILTON LLP, ONE MELLON CENTER, 50TH FLOOR, 500 GRANT STREET, PITTSBURGH, PA, 15219, US

(21) Appl. No.: 10/919,869

(22) Filed: Aug. 17, 2004

(51) Int. Cl. G06F 9/44

(52) U.S. Cl. 705/7

(57) ABSTRACT

A method for forming a strategic alliance between two or more entities is disclosed. The strategic alliance may be formed between the two or more entities to jointly manage the development, marketing, distribution and/or sale of a product and/or service sold to consumers through retailers. A joint business plan may define the goals and requirements of the strategic alliance. Each entity may contribute personnel and resources to program units for implementation of the joint business plan. The described methods of forming a strategic alliance may be used in any industry.

### TECHNICAL FIELD

The present invention relates to a method and system of forming a strategic business alliance between two or more entities to pursue a common business objective.

### BACKGROUND

Two or more companies commonly form business alliances for any number of reasons, such as to create a combined organization that is better equipped to compete in the marketplace. Alternatively, a strategic alliance may “roll up” a number of separate business entities into a single legal entity. By integrating management, achieving economies of scale and meeting other objectives, the single legal entity may increase its economic influence. Still other strategic alliances combine two or more entities, which remain separate legally, in order to jointly develop, sell, produce or market a product and/or service.

Types of business alliances include marketing contracts, contract manufacturing arrangements, partnerships, joint ventures, strategic alliances, stock purchases, asset purchases, and mergers. A marketing contract is generally an alliance in which two or more businesses remain independent but agree to market one or more products together. A contract manufacturing arrangement occurs when a manufacturing firm produces a product or a part of a product under a contract arrangement for a purchaser. The purchaser and manufacturer essentially have a customer/supplier relationship except that the purchaser determines the product specifications instead of the manufacturer. A partnership is a more closely knit relationship than a marketing contract in which the two entities join together to achieve a common goal. A partnership may be formed, for example, as a strategic alliance to produce a new product or supply a new service. A partnership for a specific purpose is often called a joint venture. The term “strategic alliance” generically applies to forms of collaboration between two or more firms, such as the following: design contracts, technology transfer agreements, joint product development agreements, purchasing agreements, distribution agreements, marketing and promotional collaboration, and intellectual advice. Stock purchases, asset purchases and mergers are undertaken when the separate legal entities desire to merge together across all business units or one entity wishes to cease operations and supply its collateral to the other entity usually in exchange for capital.

Entering into a strategic alliance requires entities to commit time and resources to the endeavor. Identifying and reaching agreement with the right company can be time consuming. Moreover, developing a strong relationship between the companies can take many years. In other words, forming a strategic alliance requires significantly more effort than simply drafting and executing an agreement.

While general guidelines exist regarding the drafting of a strategic alliance contract, a step-by-step method for forming a strategic alliance would be beneficial to virtually every business.

What is needed is a system and method of forming a strategic alliance in an expeditious manner.

A further need exists for a method and system for identifying appropriate entities with which to form a strategic alliance.

A further need exists for designing a joint business plan as part of forming the strategic alliance.

A further need exists for efficiently entering into an agreement documenting the business plan and for implementing the business plan.

The present disclosure is directed to solving one or more of the above listed problems.

### SUMMARY

Before the present methods and systems are described, it is to be understood that this invention is not limited to the particular methodologies and systems described, as these may vary. It is also to be understood that the terminology used in the description is for the purpose of describing the particular versions or embodiments only, and is not intended to limit the scope of the invention which will be limited only by the appended claims. Well-known methods and structures are not described in detail in some instances so that the invention is not unnecessarily obscured.

It must also be noted that as used herein and in the appended claims, the singular forms “a,” “an,” and “the” include plural references unless the context clearly dictates otherwise. Thus, for example, reference to a “strategic alliance” is a reference to one or more strategic alliances and equivalents thereof known to those skilled in the art, and so forth. Unless defined otherwise, all technical and scientific terms used herein have the same meanings as commonly understood by one of ordinary skill in the art. Although any methods and systems similar or equivalent to those described herein can be used in the practice or testing of embodiments of the invention, the preferred methods and systems are now described. All publications mentioned herein are incorporated by reference. Nothing herein is to be construed as an admission that the invention is not entitled to antedate such disclosure by virtue of prior invention.

In an embodiment, a method of forming a strategic alliance between two or more entities, wherein an objective of the alliance is to jointly manage the sale and marketing of a product and/or service through retailers includes: investigating possible partners, selecting a partner, meeting and explaining a business model to the partner, presenting a specific business model to the partner based on information gathered from the partner, presenting a letter of intent to the partner, designing functional requirements of a program to govern retailers' sale of the product and/or service, including determining the manufacturer's product specifications and the distributor's pricing, developing a joint business plan to manage the program, drafting and executing a contract with the partner detailing the terms of the joint business plan, developing a plan to implement the program at the retailers, launching the program at the retailers, maintaining the program through gathered input over a period of time, and creating and implementing a plan for the relationship's growth over a period of time.

In an embodiment, a method of forming a strategic alliance includes a joint business plan for a strategic alliance between two or more entities. Each entity contributes personnel and resources to a number of program units. At least one entity is a manufacturer, and at least one entity is a distributor. An objective of the joint business plan is to jointly manage the sale and marketing of a product and/or service through retailers. The joint business plan includes a marketing and program management unit, a merchandising unit, a sales unit, a supply unit, and an administrative unit. The marketing and program management unit may manage the marketing of the product and/or service, manage the relationship between the entities and the retailers, and include one or more of a program standards unit, an inventory tracking and reporting unit, a program forecasting unit, a initiative development unit, and a program website development unit. The internal sales unit may manage sales between the entities and the retailers, sales between the retailers and customers, and provide training programs to the retailers. The supply unit may manage a replenishment forecasting unit, a stocking and replenishment unit, a transportation coordination unit, a warehousing unit, and a service commitments unit. The administrative unit may include a project management unit and a billing/invoicing unit. The joint business plan may also include one or more of motivational incentives, merchandise materials, training tool development, training of the sales division, a warranty administration plan, and an enrollment plan to keep track of participating retailers.

In an embodiment, a method of creating and implementing a joint business plan for a strategic alliance between two or more entities, wherein an objective of the joint business plan is to jointly manage the sale and marketing of a product and/or service through retailers, includes: using personnel and resources of the two or more entities to establish functional requirements of a program to govern the retailers' sale of the product and/or service, developing a joint business plan to manage the program, entering into agreement to the terms of the joint business plan, creating a pilot launch plan including selection of a pilot launch site and schedule at one or more retailers and establishing criteria for evaluating the pilot launch, beginning pilot operations under the established requirements at the selected retailers, evaluating the pilot operations by gathering feedback from the retailers and assessing the results based upon established criteria, considering program revisions following pilot review, selecting launch locations and set schedules, creating a launch plan, beginning revised operations under the revised requirements at the retailers, and continuing joint management according to the joint business plan.

### DESCRIPTIONS OF THE DRAWINGS

Aspects, features, benefits and advantages of the embodiments of the present invention will be apparent with regard to the following description, appended claims and accompanying drawings where:

FIG. 1 depicts a flowchart of an exemplary method of forming a business alliance according to an embodiment.

FIG. 2 depicts an exemplary diagram of joint business plan units according to an embodiment.

FIG. 3 depicts a flowchart of an exemplary method of creating and implementing a joint business plan according to an embodiment.

### DETAILED DESCRIPTION

In the following description, various embodiments of a method and system of forming a strategic alliance are provided. The examples herein refer to a particular business plan and method, namely the formation of a business relationship between an automotive or automotive parts manufacturer and an automotive parts distributor. Specifically, a business relationship may be formed between the manufacturer and the distributor wherein automotive tires and related services are sold at the retail level. However, it is to be understood that the invention is not limited to formation in this particular industry, between these particular business entities, or to these particular entities within a supply chain. Any suitable method may be developed for entities that wish to form a strategic alliance having distribution, manufacturing, and marketing and/or sales components. The methods of forming a strategic alliance described herein may be used in any industry, between various organizations, to design a business plan wherein a new product and/or service is jointly developed, marketed, distributed and/or sold.

In an embodiment, a method of forming a business alliance includes two or more entities. At least one entity may be a distributor, and at least one entity may be a manufacturer. An objective of the method includes jointly managing the sale and marketing of a product and/or service to consumers through retailers. In an embodiment, the distributor is a tire distributor, the manufacturer is an automobile manufacturer, the retailers are automotive dealerships, and the product and/or service offered at the retailers is a tire center, which may service, repair and replace customer tires. The distributor may supply tires to the retailers' tire centers. The manufacturer may produce the automobiles on which the tires are placed.

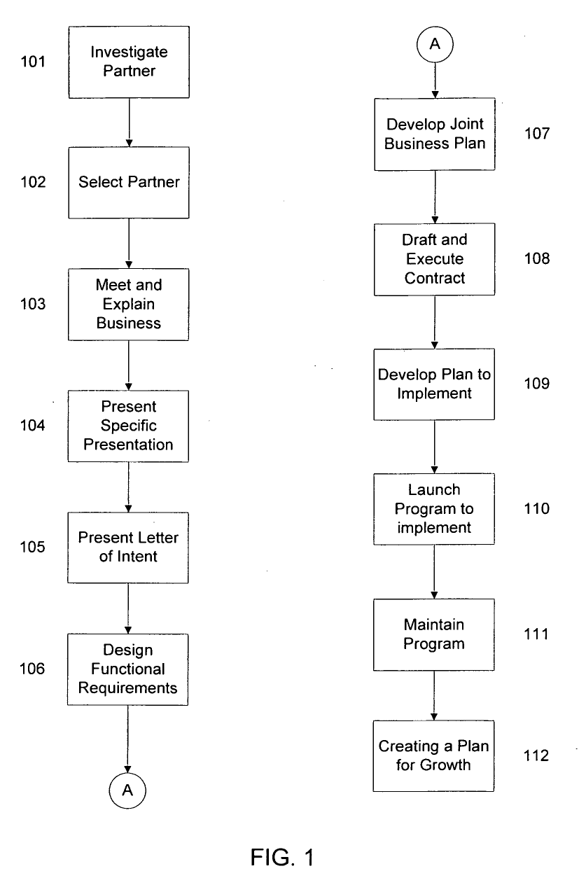

Referring to FIG. 1, a method of forming a strategic alliance may include investigating possible partners 101, selecting a partner based on one or more criteria 102, meeting and explaining a business model to the partner 103, presenting a specific business model to the partner based on information gathered from the partner 104, presenting a letter of intent to the partner 105, designing functional requirements of a program to govern sale of the product and/or service by one or more retailers, including determining manufacturer product specifications and pricing 106, developing a joint business plan to manage the program 107, drafting and executing a contract with the partner detailing the terms of the joint business plan 108, developing a plan to implement the program at the one or more retailers 109, launching the program at the one or more retailers 110, adjusting the program based on input gathered over a period of time 111, and creating and implementing a plan for the alliance's growth over a period of time 112.

Either alliance partner may initiate the process; however, the process is described below with a distributor initiating the process by contacting a manufacturer. The distributor determines one or more criteria to evaluate potential alliance partners. The criteria may include, without limitation, customer loyalty factors, profits margins of the manufacturer, original equipment fitment factors, retailer loyalty, sales volume, perceived interest in an alliance, public image factors and JD Power & Associates or other ratings.

In an embodiment, the marketing department of the distributor determines the appropriate criteria for evaluating the potential alliance partners and generates a list of acceptable or preferred potential alliance partners based on the criteria. The distributor may then further investigate one or more potential partners 101 identified on the list. After the investigation is complete, the marketing department may recommend one or more alliance partners to a business manager. The manager may then select an alliance partner 102 to target.

Once the alliance partner is selected, the distributor, through, for example, its business manager, may contact the manufacturer. Such contact may include contacting regional, domestic and/or foreign representatives. Once contacted, the distributors may delineate a proposed business model to the manufacturer 103. The business model may detail the roles of the distributor, the manufacturer and the retailers in the sale and marketing of a product and/or service. For example, the distributor may explain how it will supply products to the manufacturer's retailers, which may sell the products directly to customers. A business model in which individual retailers operate tire centers and sell tires is detailed in U.S. patent application Ser. No. 10/790,469, entitled “System and Method for Identifying Retail Tire Sales Opportunities,” and filed Mar. 1, 2004, which is incorporated herein by reference in its entirety.

The marketing and/or management departments of the distributor may explain the business model to the manufacturer. The distributor may gather information from the manufacturer in order to present an appropriate business model to the manufacturer. Such information may include the manufacturer's annual sales, the number of retailers with appropriate retail facilities, the number of retailers, warranty information, retailer sales volume, and retailer goals. Using such information, the distributor may present an overview of the business model specifically tailored to the manufacturer and its relationship with its retailers.

The distributor (or an entity initiating the alliance) may next probe and present a more detailed plan for the alliance. The distributor, through its business manager and marketing department, receives a request for proposal (RFP). The distributor may assess partner needs and goals for the potential alliance. The distributor may prepare and present a specific alliance plan to the manufacturer 104. One or more retailers may be invited to this presentation in order to encourage participation in the program by the retailers. At the presentation, a business model, which details the sales potential of initiating sale of the product and/or service, may be explained to the retailers. After the formal presentations, the two or more entities may sign a letter of intent 105 stating their desire to enter into the business alliance.

The two or more entities may design a joint business plan for their strategic alliance 106, which is specifically tailored to meet the desired needs and goals of the two entities. The joint business plan may detail both the specific roles and duties of the alliance partners and the functional requirements of the program governing the retailers' participation in the joint program. The managers, marketing personnel and alliance personnel may further determine the manufacturer's product specifications and the distributor's pricing.

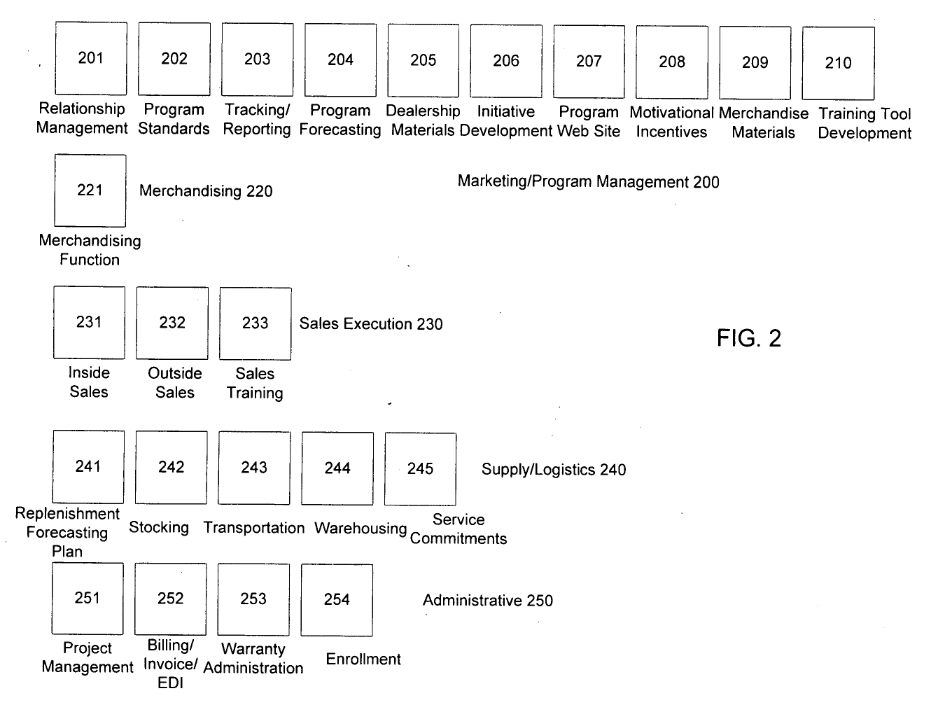

In an embodiment, the joint business plan for a strategic alliance between two or more entities may require each entity to contribute personnel and resources to a number of program units. An objective of the joint business plan may include jointly managing the sale and marketing of a product and/or service through the manufacturer's retailers. Referring to FIG. 2, the joint business plan may include the following units: a marketing and program management unit 200, a merchandising unit 220, a sales unit 230, a supply unit 240, and an administrative unit 250.

The marketing/program management unit 200 may be the unit by which the two or more entities manage the marketing of the product and/or service and the relationships with the retailers 201, the retailers' program standards for the product and/or service 202, the tracking and reporting unit 203, the program forecasting unit 204, the retailer materials unit 205, the initiative development unit 206 and a program website development unit 207.

In an embodiment, the relationship management team 201 monitors the relationship between the entities, ensuring that the program units are staffed and are working together. The team 201 may also manage retailer participation and recruitment.

The program standards unit 202 may design, develop, implement, maintain and manage the rules governing the retailers' activities and responsibilities. The program standards unit 202 may outline processes for retailers to follow.

The program standards may include enrollment requirements, enrollment fees and enrollment product minimums. In an embodiment, the program standards unit 202, in conjunction with the retailers, further establishes tire availability; the models and vehicle years for each vehicle to be included in the program; whether original equipment tires are part of the program; tire ordering procedures; pricing; whether inventory adjustments are allowed; how returns are handled; how warranty programs are administered; tire disposal and tire repair procedures; tire registration procedures; how the program handles marketing materials; training parameters of the retailers; processes for conducting needs assessments; how to coordinate manufacturer support, including whether manufacturer programs and incentives are included in the program; freight cost disbursement; inventory requirements; invoicing; and/or motivational incentives.

Enrollment requirements may be required for a retailer to participate in the program, such as completion of an enrollment form, attendance of a launch meeting, agreement to appropriate training sessions, a minimum stocking standard and/or an annual fee. The program standards unit 202 may ask retailers to complete a needs assessment form, which will provide guidelines on how to supply products to their tire service center based on annual automotive sales and other factors. For example, see U.S. application Ser. No. 10/790,469, which details a process of generating tire requirements for a retailer based on the annual number of cars sold by the retailer and the annual number of repair orders processed by a retailer's service center.

The retailers may agree to supply products, such as original equipment equivalents for vehicles with specified model years, provided by the distributor. Using an alliance provided selling and pricing guide, a retailer may agree to sell tires to the public according to the prices set by the alliance. The retailer may be provided with a guide, detailing the terms of their enrollment in the program. Other terms which may be detailed include inventory adjustments, product quality issues, warranty issues, tire disposal procedures, tire repair guidelines, consumer tire registration compliance, marketing materials use, training, needs assessment, manufacturer support, ordering, delivery, invoicing and return policies, and a certified pre-owned vehicle plan.

The tracking and reporting unit 203 handles sales tracking, reporting and objectives. Sales tracking may include web-based sales reports in which the distributor and manufacturer have access to a program website. Each retailer may have annual sales objectives that are tracked and assessed on the program website. The tracking and reporting unit 203 may also handle marketing analysis, such as research and associated analysis for the purpose of maximizing performance of the program. The tracking and reporting unit 203 may also be responsible for developing and managing the promotional activities of the retailers including promotion tracking and analysis reporting.

The program forecasting unit 204 may perform forecasting of initial sales, in order to demonstrate to retailers their tire sales potential and to gauge initial inventory needs of the retailers. The program forecasting unit 204 may gather data to forecast sales, including dealer needs assessments and inventory turn projections. The program forecasting unit 204 may use a retailer survey to gather data. From the data collected, initial needs requirements and sales potential may be calculated for a retailer. The survey and method of calculating the retailer potential and requirements may be those described in U.S. patent application Ser. No. 10/790,469.

Another component of the joint business plan is a unit that handles the coordination of the manufacturer's product materials and signs 205. Such materials may be provided to participating retailers for display. The manufacturer product materials, the manufacturer point-of-purchase materials and/or manufacturer signs may be reviewed, selected and approved by the retailer materials unit 205. This unit 205 may also handle the web merchandise ordering interface, which permits retailers to order materials through the program website. This unit 205 may further design new manufacturer product materials, brochures, point-of-purchase materials and signs.

The initiative development unit 206 manages the overall retailer program design and strategy. The initiative development unit 206 may design, develop, test, implement, maintain and manage the overall program, including setting pricing, selling requirements and the marketing strategy. The initiative development unit 206 may also make recommendations to the retailers that are initiating the program, identify strategy enhancements through ongoing assessments and suggest modifications to the design of the program.

The program website development unit 207 may design, develop, test, implement, maintain and manage a program website to facilitate the joint business plan and the management of the program. Development of the website may be initiated by setting a statement of work, setting a milestone schedule and communicating a plan. The website development may include establishing: content, security and privacy requirements, reporting requirements, an architecture questionnaire, a support requirements questionnaire, hardware requirements, a licensing strategy and/or a training requirements questionnaire.

The website may contain information related to product specifications and pricing. The website may be designed and maintained to allow the individual retailers to order their product requirements directly on-line; to manage the technical, warranty, inventory, sales, pricing and marketing data for the program products; and to train the retailers regarding the technical specification, the pricing and the warranties of the products. The program website development unit 207 updates the content, the hardware and licensing requirements associated with operating the website and the technical development and maintenance of the website.

The motivational incentives unit 208, an optional component of the marketing/program management unit 200, develops and maintains the management of sales incentive programs offered at individual retailers. The motivational incentives unit 208 recommends program incentives, monitors sales performance and recommends dealer incentive programs to stimulate product sales as needed. The unit 208 may provide sales data, track incentive sales results; review manufacturer incentive programs; provide an avenue of communication between the alliance partners; and create a web interface that allows for enrollment in and management of the incentive programs.

The merchandise materials unit 209, an optional component of the marketing/program management unit 200, may design and coordinate program merchandise materials. This unit 209 may develop a program brand “name and look,” such as a new merchandise design, which may include a new logo or product packaging. This unit 209 may also develop the content of a point-of-purchase launch box, which may include materials used to ship the contents of the program launch kit. The merchandise material may also include appointment stickers, such as a static cling windshield reminder sticker reminding a customer of her next scheduled service. This unit 209 may design and update inspection forms for the retailers' service centers for use in servicing customers' vehicles and/or a consumer brochure including tire maintenance information for consumers. The merchandising material may include specifications for service center equipment used in the tire service center, such as tire pressure and tread-depth gauges and any suitable banners, advertisements, on location signage, product displays, price tags, fact tags and product flyers.

The marketing/program management unit 200 may also include a training tool development unit 210 to develop materials to facilitate program training. The materials may include guides and scripts, training presentations, teaching aids, software programs and training sessions. The unit 210 may be responsible for the training of retail personnel and any appropriate representatives of the manufacturer. The unit 210 may distribute the materials and conduct the training programs.

The next unit of the joint business plan is the merchandising unit 220, which is responsible for the coordination of product selection and pricing 221. This unit 220 may conduct an initial product screen for products to be offered at the individual retailers; suggest stocking levels; provide retailers with access to web-based product fitment data available on the program website; provide the retailer with an analysis of the tire inventory and stock rotation; and develop initial recommended stock levels for warehouses based on customer retailers locations, penetration, probability of sales, fitment information, competitive information, availability and price. If a manufacturer or a supplier introduces a new product, this committee may organize the new product launch. The unit 220 may also determine the retailer costs for products, suggested retail pricing, promotional pricing and pricing updates. Competitive data may be gathered and utilized to ensure competitive pricing at the retail level.

The sales unit 230 may include an inside sales unit 231, an outside sales unit 232 and a sales training unit 233. The inside sales unit 231 may oversee orders placed by the retailers to the distributor. The inside sales unit 231 may coordinate the sale of products to the retailers and provide an infrastructural customer support service to receive, handle, process, deliver and fulfill Internet and non-Internet orders. A call support center may assist the retailers with program inquiries. The supervision of the sales management processes and system compliance may be handled by an inside call management center and program support team. The inside sales unit 231 may additionally provide administrative assistance to retail personnel.

The outside sales unit 232, may be responsible for seeking out, enrolling and training retail sales teams. The outside sales unit 232 may perform functions such as presenting program details to retail sales teams; working with enrolled retailers to establish inventory needs and determine initial stocking orders; scheduling, informing retail sales teams of and administering training sessions, and contacting non-enrolled retailers to encourage participation in the joint business plan.

The sales training unit 233 may coordinate the training session components to maximize program impact at the retailers. The sales training unit 233 may be responsible for producing product manuals and CD guides for the training of retailer personnel. The sales training unit 233 may also develop product merchandising manuals, services manuals, such as a tire installation manual or a tire repair manual, product sales manuals, manufacturer training materials, and web-based training programs. In an embodiment, the sales training unit 233 may provide literature to the outside sales unit 232 for training retail sales personnel.

The joint business plan also includes a supply and logistics unit 240. The supply and logistics unit 240 includes a replenishment forecasting unit 241, a stocking and replenishment unit 242, a transportation coordination unit 243, a warehousing unit 244 and a service commitments unit 245. The replenishment forecasting unit 241 may coordinate forecasting and planning processes to ensure proper product supply and provide demand forecasts to the manufacturer to ensure adequate supply point inventories that maintain order fill rates for the program. The distributor may manage the supply point inventories. The replenishment forecasting unit 241 may further utilize software or statistical analysis to forecast demand, test sales forecasting and financial forecasting against actual purchase trends, and coordinate the management and planning process for customer demand, actual sales and retailer supply.

The stocking and replenishment unit 242 may coordinate the replenishment of products to ensure adequate product supply at each retailer. Replenishment forecasting software may permit the accurate forecasting of inventory requirements and ensure an adequate supply of inventory to meet the order fill rate, fulfillment delivery and inventory turn requirements of the retailers. Replenishment inventory analysis program management and support may provide the manufacturer with order information to ensure an adequate supply of product inventory to meet the order fill rate, fulfillment and delivery requirements. The integrity of the inventory control systems may be maintained to ensure an adequate inventory and warehouse capacity and to meet delivery requirements. The timing of supply point replenishment orders may be coordinated with the product suppliers to ensure timely arrival and reasonable pricing. A forecast analysis interprets inventory data to ensure that the products' stocking levels are adjusted for forecasted demand. A stocking strategy may be developed to meet the manufacturer's needs and the distributor's financial requirements, with consideration of supply availability, demand frequency and fitment costs.

The transportation coordination unit 243 may coordinate vehicle purchases and leases to ensure that an adequate number of delivery vehicles are available to ship product from the product suppliers to the retailers; determine, implement and maintain routes for delivering products to the retailers; perform physical delivery and process acceptance of the products by the retailers; coordinate delivery efforts with the manufacturer; create adequate forms and billing procedures for transportation systems; establish order time cut-offs and delivery schedules; and negotiate and maintain delivery services agreements with carriers.

In an embodiment, the distributor has warehousing facilities in order to ensure proper product supply to the retail distributors. The warehousing unit 244 may determine the storage space and product handling equipment required to meet order fulfillment and delivery; implement a racking and locator system to facilitate movement of products within the storage space; maintain warehouse stock; prepare and package deliveries; design warehouse layouts; process product returns and warranty submissions; assemble and store product packages; ensure warehouse inventory accuracy; receive retailer inventory to be delivered; and manage inventory, preferably with at least about 99.8% accuracy.

A services commitment unit 245 of the supply and logistics unit 240 may ensure fulfillment of contractual obligations. This division monitors the alliance's activities in light of the contract terms including the fulfillment of initial stocking order, delivery time and fill rate commitments as specified in the joint business plan agreement.

The joint business plan also includes an administrative unit 250. Administrative functions include project management 251 and billing and invoicing functions 252. Optional components of the administration unit include warranty administration 253 and enrollment (or recruitment) administration 254.

Project management 251 coordinates all aspect of program development and implementation. Personnel from each of the alliance partners may coordinate these functions. Project management 251 may include the recruiting, hiring and training of new employees to staff the units of the joint business plan and the procurement of equipment to support the employees assigned to the units of the joint business plan. The project management unit 251 may schedule staff time to ensure adequate support for the plan, evaluate employee performance, determine compensation and benefits for employees assigned to the plan, and recruit, hire, train and pay sales and training personnel associated with the plan.

The billing/invoicing unit 252 may coordinate the billing process between the manufacturer, the distributor and the retailers. The retailers may place orders through the website or through the inside sales unit 231. The distributor may package and ship the products requested in the order to the retailers. The manufacturer may directly bill the retailers for the purchase orders. The purchase order may be processed between the distributor and the manufacturer in order to ensure proper invoicing by the manufacturer. In an embodiment, the billing is handled electronically. Electronic data interchange (“EDI”) compliance may be assured through the billing/invoicing unit 252. A software package may map the transport sales invoicing data from the distributor to the manufacturer for processing. Daily transmission of program sales invoicing data to the manufacturer for internal processing and retailer invoicing may also occur electronically. This unit 252 may perform system testing of the EDI billing protocol to identify and correct any program invoicing errors. The distributor may investigate and resolve sales invoicing errors that are directly related to purchases made by the distributor in support of the retailer program. Investigation and final resolution of claims and disputes with the manufacturer related to the program may also occur through the billing unit 252.

The financial structure of the program may be developed and implemented by a finance division. For example, a financial division may oversee the billing/invoicing unit 252 and, optionally, a warranty unit 253. A meeting may be conducted between the manufacturer and the distributor to discuss billing requirements. The discussions may include EDI compliance, formatting standards, debts and credits procedures and a daily pick-up process. The EDI requirements may be reviewed, including each entity's systems structure. Testing may be conducted to ensure proper processing of transactions. Various invoices may be utilized in the testing, such as an on-program invoice for product and freight.

The finance unit may also handle the master data generation and organization. Master data includes data entry regarding participating retailers including addresses, contact information, sales information, product needs assessment data and other retailer sales information. New accounts may be created as retailers are added to the program.

The finance unit may also control remittance procedures between the distributor and the manufacturer. The manufacturer and the distributor meet to discuss and establish remittance terms. Electronic funds transfer procedures may be established as well. The finance unit may handle special services, such as warranty claims. The alliance partners may design a warranty program, a marketing support program, a scrap tire program, a return policy, a freight policy and a loyalty incentive policy.

The administrative unit 250 may optionally include a warranty administration unit 253. A supplier or manufacturer may offer a warranty on products sold through the retailers. The distributor may also be involved in handling the execution of the warranty process. The design, development, testing, implementation and maintenance of the product warranty claim entry process may be handled by the warranty administrative unit 253. A web-based warranty claim entry may be implemented in which the retailers request a reimbursement and/or new product delivery in order to satisfy a warranty claim made by a customer. The joint business plan may provide for a warranty claim guide that instructs the retailers on how to process warranty claims. The joint business plan may provide warranty claim support assistance to the manufacturer. The warehouse space and overhead may be equipped to handle products returned due to processed warranty claims. The warranty administration unit 253 may obtain and distribute warranty manuals, brochures and claim forms to the retailers. The distributor may credit the retailers for covering the warranty claim with a customer after receiving acceptance of the warranty claim from the manufacturer.

Another optional component of the administrative unit is the enrollment/recruitment unit 254, which coordinates enrolling individual retailers in the established program. Retailers are recruited to the program through participation in a launch meeting or presentation. Launch meetings may be held periodically in order to explain the joint business plan to retailers in order to generate interest in the program. The enrollment unit 254 may design, develop, test, implement, maintain and manage an agenda utilized in program launch meetings; design, develop, test, implement, maintain and manage a meeting schedule and process to allow successful completion of all program launch meetings; develop and distribute invitations encouraging retailer participation in the program; track retailer attendance at the program launch meetings; conduct program launch meetings in conjunction with the manufacturer to ensure that a high percentage of retailers qualify for and enroll in the program; manage enrollment forms and processes; and solicit retailers to participate in the program through the website. An orientation process may familiarize new enrollees with the program.

The units described above may be grouped differently or perform different or additional functions and still be within the scope of the invention. In addition, fewer or more units may be implemented and still be within the scope of the invention.

Referring again to FIG. 1, after the functional requirements of the retailer program are designed 106, a joint business plan is developed 107. These two steps refer to the program units which govern the retailers' activities and participation in the program and the alliance partners' responsibilities under the joint business plan. In an embodiment, these two steps are designed together. The program requirements have been explained in reference to FIG. 2. After the program requirements are discussed among the alliance, the distributor may draft the program standards. The program standards may be submitted to the manufacturer for revisions and approval. After the program standards are finalized, the distributor may gather information from the manufacturer, such as retailer geographic information, retailer contact information and retailer sales data. Next, sales estimates may be generated for the retailers. Such calculations may be performed pursuant to the method detailed in U.S. application Ser. No. 10/790,469, where sales potential is determined from gathered retailer information. The alliance may set a meeting to discuss the launch location and schedule. Information is then communicated to units such as those described in reference to FIG. 2.

For example, after discussing the various units of the joint business plan and the desired goals of the two or more entities, the distributor may discuss potential elements and costs for various personnel. The supply chain, information technology and finance personnel of the distributor may present various components of the plan to the manufacturer. The distributor constructs and presents a quote to the manufacturer, who may accept or decline the stated quote. If the quote is rejected, the two or more entities may discuss the elements of the business plan and redesign portions of the plan. Once a quote is presented and accepted, the two entities may develop the selected business plan, including the agreed-upon elements, together 107.

The marketing and management personnel of the distributor may demonstrate the ability of the distributor to meet the obligations and requirements of the agreed-upon business plan. Once the manufacturer is satisfied, the two entities may draft and execute an alliance agreement 108.

The entities may develop a plan to implement the joint business plan 109. The two entities may prepare for and initiate an internal kickoff to launch the program at the retailers. In an embodiment, a launch presentation may be performed. The retailers may be invited to attend the launch presentation and be involved in the planning of a launch at their retailer location. The operations may be launched at selected retailers 110. The retailers may create and distribute a status report of their operations to the two entities on an on-going basis. The program may be launched and implemented at additional retailers as each qualifies for participation in the program 110.

After the program is launched at the retail level, the relationships between the alliance partners and the retailers may be maintained and developed for growth 111. An on-going gathering and analysis of partner and retailer input may be undertaken. In an embodiment, the input is used to adjust the program with the retailers accordingly over time. As the relationships strengthen, a longer-term plan may be created 112, such as a three-year plan.

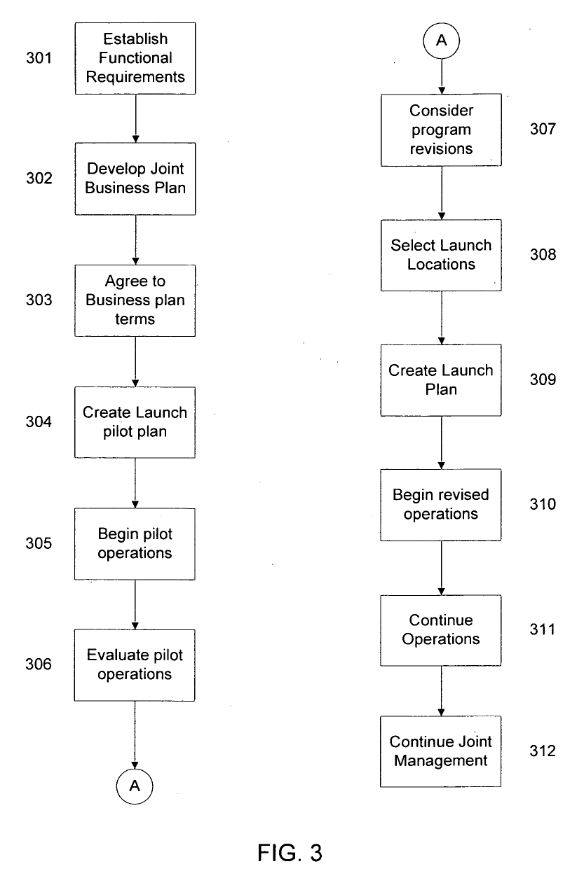

In another embodiment, a method of creating and implementing a joint business plan for a strategic alliance between two or more entities is implemented where an objective of the joint business plan is to jointly manage the sale and marketing of a product and/or service through retailers. Referring to FIG. 3, creating and implementing a joint business plan may include: establishing functional requirements of a program to govern the retailers' sale of the product and/or service 301, developing a joint business plan to manage the program 302, agreeing to the terms of the joint business plan 303, creating a pilot launch plan including selection of a pilot launch site and schedule at one or more retail distributors and establishing criteria for evaluating the pilot launch 304, initiating pilot operations under the established requirements at the selected retail distributors 305, evaluating the pilot operations by gathering feedback from the retail distributors and assessing the results based upon established criteria 306, considering program revisions 307, selecting launch locations and schedules 308, creating a launch plan 309, beginning revised operations under the revised requirements at the retailers 310, and jointly managing the revised operations according to the joint business plan 311.

The two or more entities may establish functional requirements for a program to govern the retailers' sale of the product and/or service 301. In an embodiment, the functional requirements may include establishing one or more of the units discussed in reference to FIG. 2.

The entities may develop a joint business plan 302. The distributor may prepare a presentation on the overall program and included elements of the business plan. The distributor may present a program presentation at a meeting with the manufacturer. The presentation may include determining the responsible party for various elements of the business plan. In addition, the various requirements and responsibilities of the retailers may be discussed. The communication progress may be tracked internally within the distributor's organization or externally in connection with the alliance partner. The two or more parties may then finalize the functional requirements of the program elements. The parties may then create, execute, complete and sign off on a functional project plan to fulfill the program requirements.

The parties may agree to the terms of the joint business plan 303 and, optionally, create a pilot launch plan 304 where at least one retailer is selected as a location of the pilot launch. The pilot launch is designed so that testing the program at a small number of retailers may generate program feedback before a finalized program is launched at all participating retailers. The schedule of the pilot launch and criteria for evaluating the launch may be determined. In an embodiment, the business plan may be implemented at one or more retailers without a pilot launch.

The established functional requirements of the program may govern the retailers' sale and marketing of the product and/or service under the pilot launch program. The pilot launch plan may include an evaluation period at one or more retail tire establishments. The pilot location and schedule may be selected. Pilot goals and criteria for evaluation may be determined. The pilot launch program may be adjusted to fit the selected location and schedule. The entities may hold one or more meetings to discuss the pilot launch program.

The two entities may prepare and begin an internal kickoff of the pilot launch at the one or more retail distributors, which may include a pilot kickoff meeting where one entity presents a pilot kickoff presentation, reviews the pilot launch schedule and goals. The pilot operations may begin at one or more retailers 305. Each retailer may create and distribute a status report of its operations for the two entities over time.

The pilot operations may be evaluated 306 by gathering retailer feedback on the pilot program. Pilot program results may be computed based on the established criteria. Pilot review documents may be constructed, assessed and shared among the entities. The pilot results may be used to revise the functional requirements of the program to govern the retailers' sale of the product and/or service.

The alliance partners may revise the program based on the results of the pilot program 307. The program elements may be modified to incorporate the revisions. The partners may then discuss launching the program at selected retailers 308 and create a launch plan 309.

The two or more entities may prepare and begin an internal kickoff of the launch at the retailers, which may include a kickoff presentation. A kickoff meeting may be held where the entities present a kickoff presentation, review the launch schedule and goals, and set launch locations and schedules for participating retailers. In an embodiment, the launch includes more retailers than the pilot program and initiates operations at the retail level. Additional launches may add new retailers as the retailers qualify for participation in the program.

Operations may commence at the retailers 310. From time to time, each retailer may generate and distribute a status report of its operations to the two or more entities. All units of the joint business plan may be involved in the launch including the alliance partners, the marketing unit 200, the merchandising unit 220, the sales unit 230, the logistics unit 240 and the administrative unit 250.

On an on-going basis, the program requirements may define the relationship between the retailers and the alliance partners. The alliance may operate according to the joint business plan requirements 311.

While the present invention has been described in conjunction with particular applications as outlined above, it is evident that many alternatives, modifications and variations will be apparent to one of ordinary skill in the art. Accordingly, the particular applications of this invention as set forth above are intended to be illustrative, not limiting. Modifications or changes may be made without departing from the spirit or scope of the invention, or may become obvious to one skilled in the art after review of the present invention. Such modifications or changes are intended to be included within the scope of this present application.

What is claimed is:

1. A method of forming a strategic alliance between two or more entities, wherein an objective of the alliance is to jointly manage the sale and marketing of at least one of a product and a service through one or more retailers, the method comprising:
investigating one or more possible partners;
selecting a partner based on one or more criteria;
meeting with the selected partner;
describing aspects of a business model to the selected partner;
presenting a specific business model to the selected partner;
presenting a letter of intent to the selected partner;
designing functional requirements of a program;
developing a joint business plan to manage the program;
executing a contract with the selected partner detailing the terms of the joint business plan;
developing an implementation plan to implement the program at one or more retailers;
launching the program at the one or more retailers;
maintaining the program using input gathered over time;
creating a growth plan for the growth of the relationship between the two or more entities over time; and
implementing the growth plan.

2. The method of claim 1 wherein the criteria include one or more of:
customer loyalty;
the partner's profit margins;
original equipment fitment;
loyalty of the partner's retailers;
the partner's sales volume;
perceived interest in an alliance;
the partner's reputation; and
industry ratings.

3. The method of claim 1 wherein the specific business model is based, at least in part, on information gathered from the selected partner.

4. The method of claim 3 wherein the information includes one or more of:
the selected partner's annual sales;
a number of retailers associated with the selected partner having appropriate retail facilities;
a number of retailers associated with the selected partner;
warranty information;
sales volume for retailers associated with the selected partner; and
goals for retailers associated with the selected partner.

5. The method of claim 1 wherein the functional requirements govern the one or more retailers' sale of at least one of a product and a service.

6. The method of claim 5 wherein the functional requirements include product specifications from the selected partner.

7. The method of claim 5 wherein the functional requirements include a price for at least one of a product and a service.

8. A joint business plan for a strategic alliance between two or more entities, wherein an objective of the joint business plan is to jointly manage the sale and marketing of at least one of a product and a service through retailers, the joint business plan comprising:
a marketing/program management unit;
a merchandising unit for coordinating product selection and pricing;
a sales unit;
a supply and logistics unit; and
an administrative unit,
wherein each of two or more entities contributes personnel and resources to at least one of the units, wherein at least one entity is a manufacturer, wherein at least one entity is a distributor.

9. The joint business plan of claim 8 wherein the marketing and program management unit manages the marketing of at least one of a product and a service.

10. The joint business plan of claim 8 wherein the marketing and program management unit manages the relationship among the entities and the retailers.

11. The joint business plan of claim 8 wherein the marketing and program management unit includes one or more of:
a program standard unit for managing one or more program standards governing activities and responsibilities of the one or more retailers with respect to the joint business plan;
an inventory tracking and reporting unit for performing sales tracking and marketing analysis;
a program forecasting unit for forecasting sales and needs requirements;
a retailer materials unit for providing product materials, point-of-purchase displays and manufacturer signs to retailers;
an initiative development unit for setting retailer prices, sales goals, and marketing requirements; and
a program website development unit for managing a program website.

12. The joint business plan of claim 11 wherein the program standards include one or more of the following:
an enrollment requirement;
an enrollment fee;
an enrollment product minimum;
a product availability requirement;
a product ordering procedure;
a pricing requirement;
an inventory adjustment procedure;
a product return procedure;
a warranty administration procedure;
a product repair procedure;
a product registration procedure;
a training requirement;
a needs assessment procedure;
a manufacturer support procedure;
a manufacturer incentive program;
a freight cost disbursement;
an inventory requirement; and
a motivational incentive.

13. The joint business plan of claim 11 wherein the marketing and program management unit further includes one or more of:
a motivational incentives unit for managing sales incentive programs at the retailers;
a merchandise materials unit for developing marketing materials associated with the joint business plan; and
a training tool development unit for developing materials to facilitate retailer training.

14. The joint business plan of claim 8 wherein the sales unit includes one or more of the following:
an internal sales unit for managing sales between the entities and the retailers;
an external sales unit for managing sales between the retailers and their customers; and
a sales training unit for providing training programs to the retailers.

15. The joint business plan of claim 8 wherein the supply and logistics unit includes one or more of:
a replenishment forecasting unit for coordinating forecasting and planning processes to ensure proper product supply;
a stocking and replenishment unit for coordinating replenishment of products to ensure adequate product supply at each retailer;
a transportation coordination unit for coordinating delivery of products to retailers;
a warehousing unit for managing storage facilities for products; and
a service commitments unit for ensuring fulfillment of contractual obligations under the joint business plan.

16. The joint business plan of claim 8 wherein the administrative unit includes one or more of:
a project management unit for managing staffing requirements and procuring support equipment; and
a billing and invoicing unit for coordinating the billing and invoicing procedures among the entities and the retailers.

17. The joint business plan of claim 16 wherein the administrative unit further includes one or more of:
a warranty administration unit for administering a warranty claim process; and
an enrollment administration unit for recruiting and enrolling retailers in the joint business plan.

18. A method of creating and implementing a joint business plan for a strategic alliance between two or more entities, wherein an objective of the joint business plan is to jointly manage the sale and marketing at least one of a product and a service through one or more retailers, the method comprising:
using personnel and resources of two or more entities to establish functional requirements of a program that govern one or more retailers' sale of at least one of a product and a service;
developing a joint business plan to manage the program;
agreeing, by the entities, to the terms of the joint business plan;
selecting one or more launch locations;
creating a launch plan including a launch plan schedule;
initiating the program at one or more retailers; and
managing the program according to the joint business plan.

19. The method of claim 18, further comprising:
creating a pilot launch plan including selection of a pilot launch site and a pilot schedule at one or more pilot retailers;
establishing criteria for evaluating the pilot launch;
beginning pilot operations at the one or more pilot retailers;
gathering feedback from the one or more pilot retailers;
evaluating the pilot operations based upon the established criteria and the gathered feedback; and
revising the program based on the evaluation of the pilot operations.
